(19) United States
(12) Patent Application Publication
(10) Pub. No.: US 2021/0245299 A1
(43) Pub. Date: Aug. 12, 2021

(54) LASER PROCESSING APPARATUS

(71) Applicant: DISCO CORPORATION, Tokyo (JP)

(72) Inventors: Yukiyasu MASUDA, Tokyo (JP); Yuichi KITAZUMI, Tokyo (JP)

(21) Appl. No.: 17/162,203

(22) Filed: Jan. 29, 2021

(30) Foreign Application Priority Data
Feb. 10, 2020 (JP) 2020-020767

(51) Int. Cl. B23K 26/142; B23K 26/02

(52) U.S. Cl. CPC B23K 26/142; B23K 26/02

(57) ABSTRACT

A laser processing apparatus includes a debris discharging unit disposed in a space between a beam condenser and a workpiece on a chuck table, for drawing and discharging plasma or debris produced at a processing spot on the workpiece by a laser beam applied to a face side of the workpiece. The debris discharging unit includes a dust collecting unit and a suction source connected to the dust collecting unit. The dust collecting unit includes a slanted portion, a ceiling, a bottom wall, and a pair of side walls.

### BACKGROUND OF THE INVENTION

### Field of the Invention

The present invention relates to a laser processing apparatus.

### Description of the Related Art

There has been known a laser processing method that divides a workpiece such as a semiconductor wafer by applying a laser beam to the workpiece to form laser-processed grooves in the workpiece by way of ablation (see, for example, JP 2007-069249A).

### SUMMARY OF THE INVENTION

The laser processing method described above is liable to produce fine particles of dust called plasma or debris from the workpiece when the workpiece is processed by the laser beam. If such plasma or debris is present in the vicinity of the point where the workpiece is processed, it tends to interact with the laser beam, causing the problem of having adverse effects on the processed workpiece. JP 2007-069249A has proposed a configuration for solving the above problem that includes a dust collecting unit for collecting debris, etc., produced when the workpiece is processed, thereby removing the debris, etc., from the workpiece. However, since the dust collecting unit disclosed in JP 2007-069249A draws plasma or debris from all around the laser beam, the plasma or debris moves across the laser beam when drawn by the dust collecting unit, making it difficult to fully eliminate its interaction with the laser beam.

It is therefore an object of the present invention to provide a laser processing apparatus that restrains debris or plasma produced from a workpiece when the workpiece is processed by a laser beam, from interacting with the laser beam.

In accordance with an aspect of the present invention, there is provided a laser processing apparatus including a chuck table for holding a plate-shaped workpiece thereon, a laser beam applying unit including a beam condenser for applying a laser beam to a face side of the workpiece held on the chuck table to form laser-processed grooves in the workpiece by way of ablation, and a debris discharging unit disposed in a space between the beam condenser and the workpiece on the chuck table, for drawing and discharging debris produced at a processing spot on the workpiece by the laser beam applied to the face side of the workpiece. The debris discharging unit includes a dust collecting unit and a suction source connected to the dust collecting unit. The dust collecting unit includes a slanted portion including a transmitting portion for allowing the laser beam to pass therethrough and having a first side adjacent to the workpiece on the chuck table and a second side remote from the first side, a ceiling coupled to the second side, a bottom wall having an opening defined therein for allowing the laser beam to pass therethrough, at a position aligned with the transmitting portion, the bottom wall being coupled to the first side, and a side wall extending from the ceiling and the slanted position to the bottom wall.

Preferably, the slanted portion is inclined with respect to the bottom wall at an angle ranging from 20 to 40 degrees. Preferably, the debris discharging unit has an ejection port defined closely to the opening, and further includes an assisting gas ejecting unit for ejecting a gas from the ejection port toward the face side of the workpiece on the chuck table to blow away the debris produced at the processing spot into the dust collecting unit.

Preferably, the assisting gas ejecting unit is oriented with respect to the slanted portion at an angle that is 10 degrees±an angle perpendicular to the slanted portion. Preferably, the dust collecting unit has a reduced-diameter section that is progressively smaller in diameter from the suction source toward the processing spot.

According to the present invention, debris or plasma produced from a workpiece when the workpiece is processed by a laser beam is restrained from interacting with the laser beam.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view illustrating an example of a configuration of a laser processing apparatus according to an embodiment of the present invention;

FIG. 2 is a perspective view of a debris discharging unit of the laser processing apparatus illustrated in FIG. 1;

FIG. 3 is a cross-sectional view of the debris discharging unit illustrated in FIG. 2;

FIG. 4 is a cross-sectional view illustrating the manner in which the debris discharging unit illustrated in FIG. 2 operates;

FIG. 5 is a plan view illustrating the manner in which a laser processing apparatus according to modification 1 of the embodiment operates; and

FIG. 6 is a plan view illustrating the manner in which a laser processing apparatus according to modification 2 of the embodiment operates.

### DETAILED DESCRIPTION OF THE PREFERRED EMBODIMENT

A preferred embodiment of the present invention will hereinafter be described in detail with reference to the drawings. The present invention is not limited to the details of the embodiment described below. The components described below cover those which could easily be envisaged by those skilled in the art and those which are essentially identical to those described above. Further, the configurations described below can be used in appropriate combinations. Various omissions, replacements, or changes of the configurations may be made without departing from the scope of the present invention.

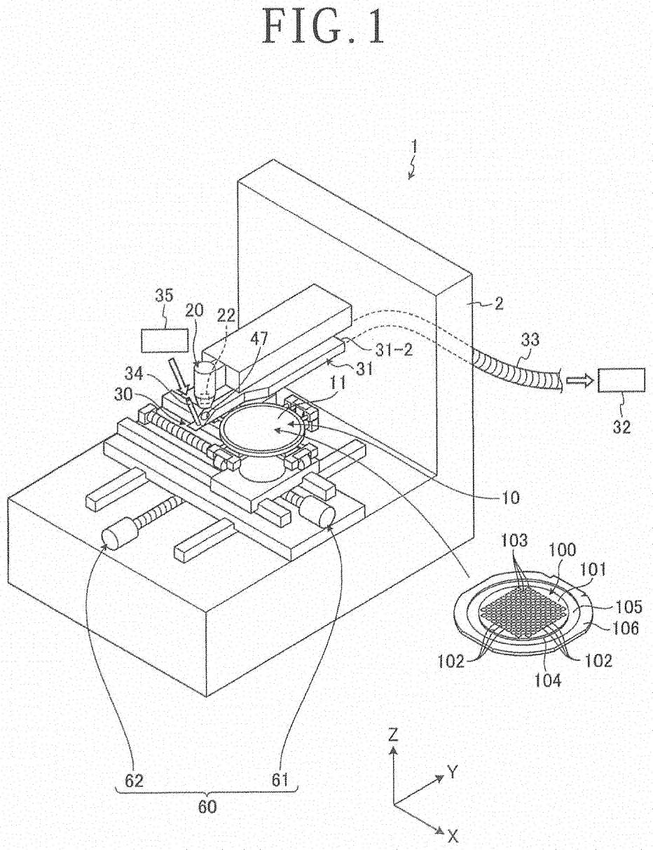

A laser processing apparatus 1 according to the preferred embodiment of the present invention will be described below with reference to the drawings. FIG. 1 illustrates in perspective an example of a configuration of the laser processing apparatus 1 according to the embodiment. As illustrated in FIG. 1, the laser processing apparatus 1 according to the embodiment includes a chuck table 10, a laser beam applying unit 20, and a debris discharging unit 30. The laser processing apparatus 1 is an apparatus for forming laser-processed grooves in a plate-shaped workpiece 100 held on the chuck table 10 by way of ablation by applying a laser beam 25 (see FIG. 3) from the laser beam applying unit 20 to a flat face side 101 of the workpiece 100.

The workpiece 100, which acts as an object to be processed by the laser beam 25 on the laser processing apparatus 1, may be, for example, a wafer such as a disk-shaped semiconductor wafer or an optical device wafer made of a base material such as silicon, sapphire, or gallium arsenide. The workpiece 100 has a plurality of devices 103 formed in respective areas on the face side 101 that are demarcated by a grid of projected dicing lines 102 established on the face side 101. The workpiece 100 has a reverse side 104 opposite the face side 101 with an adhesive tape 105 affixed to the reverse side 104. The adhesive tape 105 has an outer edge portion on which an annular frame 106 is mounted. According to the present invention, the workpiece 100 may alternatively be a rectangular packaged substrate, a ceramic plate, a glass plate, or the like with a plurality of resin-encapsulated devices formed thereon.

The chuck table 10 has a flat holding surface 11 for holding the workpiece 100 thereon. The chuck table 10 is of a disk shape including a disk-shaped suction member having an upper surface as the flat holding surface 11 and made of porous ceramic or the like including a number of pores therein, and a frame having a recess defined centrally in an upper surface thereof with the suction member fixedly fitted in the recess. The holding surface 11 lies parallel to an XY plane that provides a horizontal plane. The suction member of the chuck table 10 is connected to a vacuum suction source, not illustrated, through a vacuum suction channel, not illustrated. When the vacuum suction source is actuated, it generates and applies a vacuum or negative pressure through the vacuum suction channel and the pores to the holding surface 11, holding the workpiece 100 under suction thereon in its entirety.

The chuck table 10 is movable in X-axis directions as horizontal directions by an X-axis moving unit 61. The chuck table 10 is also movable in Y-axis directions as other horizontal directions perpendicular to the X-axis directions by a Y-axis moving unit 62. The X-axis moving unit 61 and the Y-axis moving unit 62 are also referred to collectively as a moving unit 60. The moving unit 60 moves the chuck table 10 in the X-axis directions or the Y-axis directions to move the laser beam applying unit 20, the chuck table 10, and the workpiece 100 held on the chuck table 10 relatively to each other in the X-axis directions or the Y-axis directions. On the laser processing apparatus 1 according to the present embodiment, the X-axis directions may also be referred to as processing feed directions and the Y-axis directions as indexing feed directions.

As illustrated in FIG. 1, the laser beam applying unit 20 is fixedly mounted on a main base 2 of the laser processing apparatus 1. The laser beam applying unit 20 includes a laser oscillating unit, not illustrated, and a beam condenser 22. The laser oscillating unit oscillates a laser beam 25 (see FIG. 3) having a predetermined wavelength. The beam condenser 22 is an optical device that converges the laser beam 25 oscillated by the laser oscillating unit and applies the converged laser beam 25 to the workpiece 100 held on the chuck table 10. According to the present embodiment, the beam condenser 22 includes a condensing lens 23 (see FIG. 3), for example.

The laser beam applying unit 20 forms laser-processed grooves in the face side 101 of the workpiece 100 held on the chuck table 10 by way of ablation by converging the laser beam 25 oscillated by the laser oscillating unit with the beam condenser 22 and applying the converged laser beam 25 to the face side 101 of the workpiece 100.

Specifically, the laser beam applying unit 20 forms laser-processed grooves along the projected dicing lines 102 in the face side 101 of workpiece 100 held on the chuck table 10 by moving the laser beam 25 relatively to the workpiece 100 along the projected dicing lines 102 while applying the converged laser beam 25 to the face side 101 of the workpiece 100.

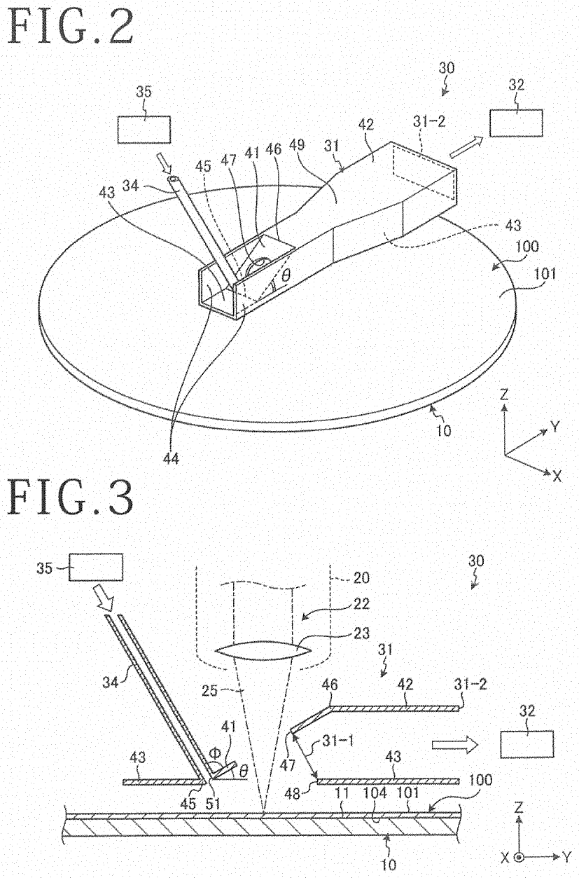

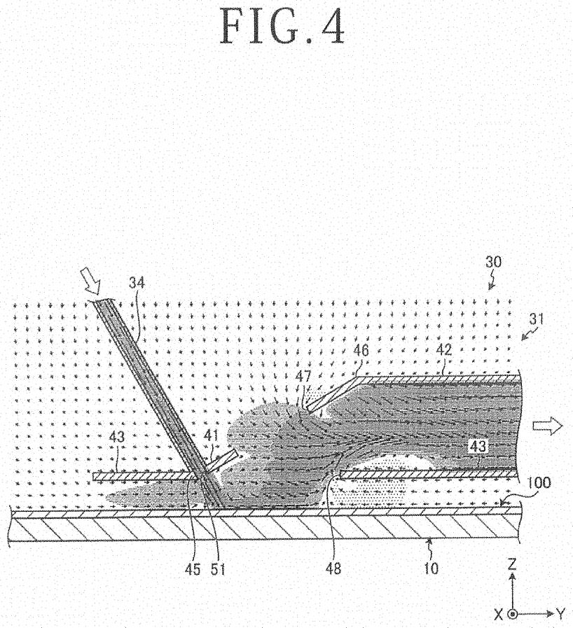

FIG. 2 illustrates in perspective the debris discharging unit 30 of the laser processing apparatus 1 illustrated in FIG. 1. FIG. 3 illustrates in cross section the debris discharging unit 30 illustrated in FIG. 2. FIG. 4 illustrates in cross section the manner in which the debris discharging unit 30 illustrated in FIG. 2 operates. The debris discharging unit 30 as a component of the laser processing apparatus 1 according to the present embodiment will hereinafter be described with reference to FIGS. 1 through 4.

As illustrated in FIG. 1, the debris discharging unit 30 is fixedly mounted on the main base 2 beneath the laser beam applying unit 20. When the chuck table 10 that is holding the workpiece 100 thereon is disposed below the beam condenser 22 of the laser beam applying unit 20, the debris discharging unit 30 is positioned in a space between the beam condenser 22 and the workpiece 100, as illustrated in FIG. 3.

As illustrated in FIGS. 1 through 3, the debris discharging unit 30 includes a dust collecting unit 31, a suction source 32, a duct 33, an assisting gas ejecting unit 34, and an assisting gas supply source 35. As illustrated in FIGS. 2 and 3, the dust collecting unit 31 is shaped as a generally elongate box-shaped member having defined therein a space for collecting and discharging fine particles of dust called plasma or debris produced from the workpiece 100 in the vicinity of the spot, also referred to as a processing spot, where the workpiece 100 is processed by way of ablation. The dust collecting unit 31 has an end portion disposed beneath the beam condenser 22 and having a transmitting portion 47 and an opening 48 at a position corresponding to the path below the beam condenser 22 along which the laser beam 25 from the beam condenser 22 is applied to the workpiece 100. As illustrated in FIG. 3, the dust collecting unit 31 has a suction port 31-1 disposed in the end portion thereof and oriented generally toward the processing spot for drawing plasma and debris produced in the vicinity of the processing spot into the dust collecting unit 31. The suction port 31-1 is defined between an end of the transmitting portion 47 and an end of the opening 48, the ends being closer to another end of the dust collecting unit 31 that is remote from the end portion thereof referred to above. The other end of the dust collecting unit 31 is fixed to the main base 2 and has another suction port 31-2 defined therein. The duct 33 is connected to the suction port 31-2, and the suction source 32 is connected to the suction port 31-2 through the duct 33.

When the suction source 32 is actuated, it generates and draws streams of air through the dust collecting unit 31 and the duct 33 toward itself, evacuating the dust collecting unit 31 from the suction port 31-2. When the assisting gas ejecting unit 34 ejects an assisting gas, as described later, since the ejected assisting gas is also drawn into the dust collecting unit 31 by the suction source 32, the air flow generated through the dust collecting unit 31 by the suction source 32 contains the ejected assisting gas in the dust collecting unit 31. The suction source 32 also draws in plasma and debris introduced into the dust collecting unit 31 from the processing spot through the suction port 31-1 to flow on the streams of air through the dust collecting unit 31 and then through the suction port 31-2, and discharges them. The duct 33 connects the suction port 31-2 of the dust collecting unit 31 and the suction source 32 to each other.

As illustrated in FIGS. 2 and 3, the dust collecting unit 31 has a slanted portion 41, a ceiling 42, a bottom wall 43, and a pair of side walls 44. The slanted portion 41 is in the form of a plate-shaped member inclined at an angle of θ to the horizontal directions, and may be made of sheet metal, for example. According to the present embodiment, the angle of θ ranges from 20 to 40 degrees, and should preferably be approximately 30 degrees.

The slanted portion 41 is of a rectangular shape having a first side 45 and a second side 46 that extend along the X-axis directions and a pair of oblique sides interconnecting respective ends of the first and second sides 45 and 46 and other respective ends of the first and second sides 45 and 46.

The first side 45 is disposed closely to the workpiece 100 on the chuck table 10. Specifically, the first side 45 is disposed closer to the face side 101 of the workpiece 100 on the chuck table 10 than the second side 46. The second side 46 is remote from the workpiece 100 on the chuck table 10. Specifically, the second side 46 is remoter from the face side 101 of the workpiece 100 on the chuck table 10 than the first side 45. According to the present embodiment, the first side 45 and the holding surface 11 of the chuck table 10 are spaced from each other by a vertical distance of approximately 5 mm.

The slanted portion 41 has the transmitting portion 47 defined centrally therein for allowing the laser beam 25 to pass therethrough. According to the present embodiment, the transmitting portion 47 is in the form of a substantially circular opening having a diameter in the range from 25 to 30 mm. According to the present invention, however, the transmitting portion 47 is not limited to such a substantially circular opening, but may be of any form insofar as it allows the laser beam 25 to pass therethrough. For example, the transmitting portion 47 may be a window filled with a light-transmissive plate that prevents air from flowing therethrough.

The ceiling 42 is in the form of a plate-shaped member having an end joined to the second side 46 of the slanted portion 41 and extending horizontally from the second side 46 to the suction port 31-2, and may be made of sheet metal, for example. The bottom wall 43 is in the form of a plate-shaped member having an end joined to the first side 45 of the slanted portion 41 and extending horizontally from the first side 45 to the suction port 31-2, and may be made of sheet metal, for example. The ceiling 42 and the bottom wall 43 extend parallel to each other, and lie parallel to the face side 101 of the workpiece 100 on the chuck table 10. The ceiling 42 and the bottom wall 43 define a ceiling surface and a bottom surface, respectively, of the space in the dust collecting unit 31.

The bottom wall 43 and the holding surface 11 of the chuck table 10 are spaced from each other by a vertical distance that is equal to the vertical distance between the first side 45 and the holding surface 11 of the chuck table 10. According to the present embodiment, the vertical distance between the bottom wall 43 and the holding surface 11 of the chuck table 10 is set to approximately 5 mm.

The bottom wall 43 has the opening 48 defined therein for allowing the laser beam 25 to pass therethrough at the position corresponding to the path below the beam condenser 22 along which the laser beam 25 from the beam condenser 22 is applied to the workpiece 100. The transmitting portion 47 defined in the slanted portion 41 and the opening 48 defined in the bottom wall 43 are generally vertically opposite each other, and they both allow the laser beam 25 to pass therethrough. According to the present embodiment, the opening 48 is of a substantially square or rectangular shape having a size ranging from 20 to 30 mm. According to the present invention, however, the opening 48 is not limited to such a substantially square or rectangular shape, but may be of any shape insofar as it allows the laser beam 25 to pass therethrough and also allows plasma or debris produced in the vicinity of the processing spot on the workpiece 100 to which the laser beam 25 is applied to pass therethrough.

Each of the side walls 44 is in the form of a plate-shaped member extending vertically from the slanted portion 41 and the ceiling 42 to the bottom wall 43, and may be made of sheet metal, for example. The side walls 44 define the horizontal width of the space in the dust collecting unit 31.

The dust collecting unit 31 may be made narrower to speed up the streams of air produced therein by the suction source 32. Specifically, the dust collecting unit 31 may be made narrower by reducing the cross-sectional area thereof (hereinafter referred to as a “dust collecting unit cross-sectional area”) perpendicular to the streams of air produced in the space in the dust collecting unit 31 by the suction source 32. On the other hand, the dust collecting unit 31 may be made wider to make plasma or debris less liable to stay in the space in the dust collecting unit 31 and hence to prevent the space in the dust collecting unit 31 from being loaded with plasma or debris. Specifically, the dust collecting unit 31 may be made wider by increasing the dust collecting unit cross-sectional area. Consequently, the dust collecting unit 31 may be made narrower or wider on the basis of the streams of air produced in the space in the dust collecting unit 31 by the suction source 32 and the way in which plasma or debris less stays in the space in the dust collecting unit 31.

The dust collecting unit 31 has a reduced-diameter section 49 that is progressively smaller in diameter from a suction source 32 side of the dust collecting unit 31 toward a processing spot side of the dust collecting unit 31. The suction source 32 side of the dust collecting unit 31 refers to the other end of the dust collecting unit 31 where the suction port 31-2 is defined. The processing spot side of the dust collecting unit 31 refers to the end portion of the dust collecting unit 31 where the transmitting portion 47 and the opening 48 corresponding to the path along which the laser beam 25 is applied to the workpiece 100 are defined and also the suction port 31-1 is defined. The dust collecting unit 31 may be made progressively smaller in diameter from the suction source 32 side toward the processing spot side by gradually reducing the dust collecting unit cross-sectional area from the other end toward the end portion of the dust collecting unit 31. In the reduced-diameter section 49, the dust collecting unit cross-sectional area is gradually reduced from the other end toward the end portion of the dust collecting unit 31 by gradually reducing the widths of the ceiling 42 and the bottom wall 43 and the distance between the side walls 44 from the other end toward the end portion of the dust collecting unit 31. However, the reduced-diameter section 49 is not limited to such a configuration. Rather, the dust collecting unit cross-sectional area may be gradually reduced from the other end toward the end portion of the dust collecting unit 31 by gradually reducing the distance by which the ceiling 42 and the bottom wall 43 are spaced from each other, i.e., the distance between the ceiling 42 and the bottom wall 43, from the other end toward the end portion of the dust collecting unit 31. The dust collecting unit 31 that includes the reduced-diameter section 49 is effective to speed up the streams of air in the space in the dust collecting unit 31 and also to prevent the space in the dust collecting unit 31 from being loaded with plasma or debris in a balanced fashion.

As illustrated in FIGS. 2 and 3, the assisting gas ejecting unit 34 is in the form of a generally elongate tubular member having an axial end connected to the assisting gas supply source 35 and another axial end with an ejection port 51 defined therein for ejecting a gas, i.e., an assisting gas, supplied from the assisting gas supply source 35 along a direction of the axis of the generally elongate tubular member (hereinafter referred to as a “tubular axial direction”). According to the present embodiment, the assisting gas ejecting unit 34 includes a nozzle having an inside diameter in the range from 1 to 2 mm.

The tubular axial direction of the assisting gas ejecting unit 34 represents a direction in which the ejection port 51 thereof is oriented, i.e., a direction along which the assisting gas is ejected from the assisting gas ejecting unit 34 via the ejection port 51. The ejection port 51 of the assisting gas ejecting unit 34 is positioned in the vicinity of the opening 48. According to the present embodiment, the ejection port 51 is positioned at an end of the opening 48 that is closer to the end portion referred to above of the dust collecting unit 31, i.e., at an end of the opening 48 near the first side 45 of the slanted portion 41. The assisting gas ejecting unit 34 ejects the assisting gas from the assisting gas supply source 35 via the ejection port 51 toward the face side 101 of the workpiece 100 on the chuck table 10, blowing away plasma or debris produced in the vicinity of the processing spot into the suction port 31-1 of the dust collecting unit 31. The suction port 31-1 of the dust collecting unit 31 and the ejection port 51 of the assisting gas ejecting unit 34 are disposed relatively to each other such that the transmitting portion 47 and the opening 48 are positioned therebetween as viewed in plan from above along Z-axis directions.

The assisting gas ejecting unit 34 extends from an upper surface of the slanted portion 41 through an area of the slanted portion 41 that is closer to the first side 45 than to the transmitting portion 47. According to the present embodiment, the assisting gas ejecting unit 34 is oriented with respect to the slanted portion 41 at an angle that is 10 degrees±the angle perpendicular to the slanted portion 41. Specifically, the angle Φ illustrated in FIG. 3 between the tubular axial direction of the assisting gas ejecting unit 34 and the slanted surface of the slanted portion 41 is set to an angle of 90 degrees±10 degrees, i.e., an angle ranging from 80 to 100 degrees. According to the present embodiment, a direction in which the angle θ between the slanted surface of the slanted portion 41 and the horizontal directions lies is the same as a direction in which the angle Φ between the tubular axial direction of the assisting gas ejecting unit 34 and the slanted surface of the slanted portion 41 lies. As illustrated in FIG. 3, the angle θ and the angle Φ are plotted in one plane.

Operation of the laser processing apparatus 1 thus configured according to the present embodiment will be described below. The laser processing apparatus 1 forms laser-processed grooves in the workpiece 100 on the chuck table 10 by way of ablation by applying the laser beam 25 from the laser beam applying unit 20 to the face side 101 of the workpiece 100. While applying the laser beam 25 to the workpiece 100, the laser processing apparatus 1 ejects the assisting gas from the assisting gas ejecting unit 34 of the debris discharging unit 30 via the ejection port 51 toward the face side 101 of the workpiece 100, and also produces streams of air flowing in the dust collecting unit 31 from the suction port 31-1 toward the suction port 31-2 with the suction source 32 of the debris discharging unit 30.

FIG. 4 schematically illustrates streams of air, indicated by a plurality of arrows and different shades, produced in the dust collecting unit 31 at the time the assisting gas ejecting unit 34 ejects the assisting gas via the ejection port 51 toward the face side 101 of the workpiece 100 and the suction source 32 draws air in the dust collecting unit 31 from the suction port 31-1 to the suction port 31-2. In FIG. 4, the directions of the arrows represent the directions of the streams of air in areas indicated by the arrows, and the sizes of the arrows represent the sizes or the speeds of the streams of air in the areas indicated by the arrows. The darker shades represent areas where the streams of air are larger, and lighter shades represent areas where the streams of air are smaller. When the laser processing apparatus 1 thus ejects the assisting gas from the assisting gas ejecting unit 34 and draws air with the suction source 32, the assisting gas ejected from the ejection port 51 of the assisting gas ejecting unit 34 impinges upon the face side 101 of the workpiece 100, and air containing plasma or debris produced in the vicinity of the processing spot, including the transmitting portion 47 and the opening 48, by the laser beam 25 is drawn into the dust collecting unit 31 from the end portion thereof, generating streams of air in the dust collecting unit 31 that is slightly higher than the face side 101 of the workpiece 100 and drawing the generated streams of air toward the other end of the dust collecting unit 31.

The laser processing apparatus 1 according to the present embodiment includes the debris discharging unit 30 that is positioned in the space between the beam condenser 22 and the workpiece 100 and draws and discharges plasma or debris produced in the vicinity of the processing spot by the laser beam 25 applied to the workpiece 100. The debris discharging unit 30 includes the dust collecting unit 31 and the suction source 32 connected to the dust collecting unit 31, and the dust collecting unit 31 has the slanted portion 41, the ceiling 42, the bottom wall 43, and the pair of side walls 44. The slant of the slanted portion 41 is effective to prevent plasma or debris produced at the processing spot from being scattering upwardly and to control plasma or debris to flow in a horizontal direction toward the other end of the dust collecting unit 31. The laser processing apparatus 1 according to the present embodiment is thus able to restrain plasma or debris produced at the processing spot from moving across the laser beam 25 and hence to prevent plasma or debris produced when the workpiece 100 is processed from interacting with the laser beam 25.

In the laser processing apparatus 1 according to the present embodiment, the slanted portion 41 is inclined to the horizontal directions at the angle of θ ranging from 20 to 40 degrees. Since the angle at which the slanted portion 41 is inclined to the horizontal directions at a sufficiently large angle of 20 degrees or more, it is possible to space the ceiling 42 and the bottom wall 43 from each other by a sufficiently large distance. Consequently, debris or plasma can appropriately be collected and drawn in the space in the dust collecting unit 31. Further, since the angle at which the slanted portion 41 is inclined to the horizontal directions at a sufficiently small angle of 40 degrees or less, the slanted portion 41 is able to sufficiently eliminate the possibility that debris or plasma may fly onto the optical axis of the laser beam 25.

In addition, in the laser processing apparatus 1 according to the present embodiment, the debris discharging unit 30 further includes the assisting gas ejecting unit 34. The assisting gas ejected from the assisting gas ejecting unit 34 blows away plasma or debris produced at the processing spot into the suction port 31-1 of the dust collecting unit 31 and then toward the other end thereof. The laser processing apparatus 1 is thus able to more reliably prevent plasma or debris produced when the workpiece 100 is processed from interacting with the laser beam 25.

Moreover, the assisting gas ejecting unit 34 is oriented with respect to the slanted portion 41 at the angle that is 10 degrees±the angle perpendicular to the slanted portion 41. Since the laser processing apparatus 1 according to the present embodiment can accordingly eject the assisting gas from the assisting gas ejecting unit 34 obliquely to the face side 101 of the workpiece 100, the speed at which the assisting gas flows horizontally on the face side 101 of the workpiece 100 can be made high. Therefore, the laser processing apparatus 1 according to the present embodiment can increase the speed of the streams of air produced in the dust collecting unit 31 and drawn toward the other end thereof by the suction source 32, and can also draw plasma or debris produced at the processing spot more strongly in the horizontal direction, i.e., in the direction toward the other end of the dust collecting unit 31, with the debris discharging unit 30. The laser processing apparatus 1 according to the present embodiment can thus more reliably restrain plasma or debris produced when the workpiece 100 is processed from interacting with the laser beam 25.

In the laser processing apparatus 1 according to the present embodiment, furthermore, the dust collecting unit 31 has the reduced-diameter section 49 where the dust collecting unit 31 is progressively smaller in diameter from the suction source 32 toward the processing spot. The reduced-diameter section 49 is effective to speed up the streams of air in the space in the duct collecting unit 31 and also to prevent the space in the dust collecting unit 31 from being loaded with plasma or debris in a balanced fashion.

### [Modification 1]

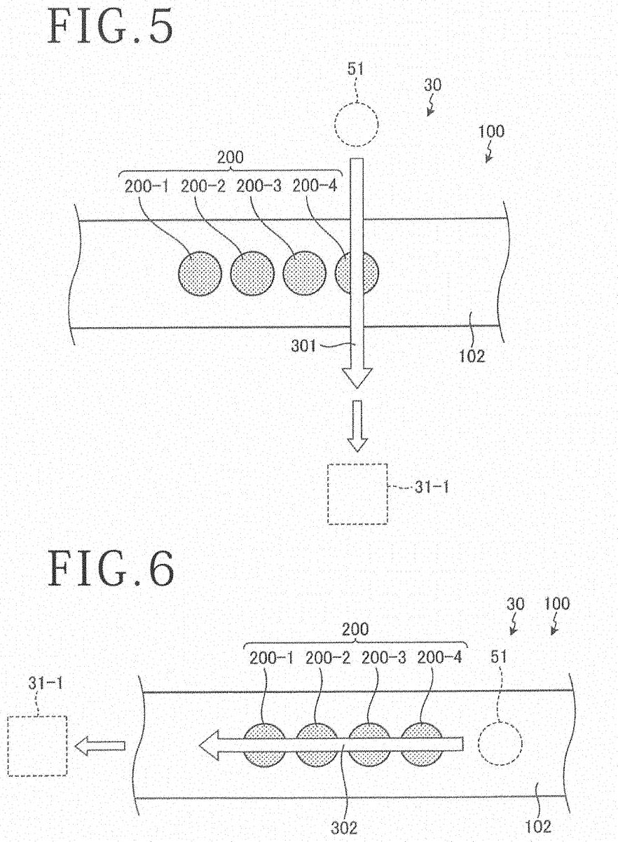

A laser processing apparatus 1 according to modification 1 of the present embodiment will be described below with reference to FIG. 5. FIG. 5 illustrates in plan the manner in which the laser processing apparatus 1 according to modification 1 of the embodiment operates. Those parts illustrated in FIG. 5 that are identical to those according to the embodiment are denoted by identical reference characters and will not be described in detail below.

As illustrated in FIG. 5, in the laser processing apparatus 1 according to modification 1, the directions in which the X-axis moving unit 61 moves to move the workpiece 100 in the X-axis directions, i.e., the processing feed directions, and the directions along which the suction port 31-1 of the dust collecting unit 31 and the ejection port 51 of the assisting gas ejecting unit 34 face each other as viewed in plan extend perpendicularly to each other. The directions in which the X-axis moving unit 61 moves refer to the directions in which the laser beam applying unit 20 and the workpiece 100 move relatively to each other. The directions along which the suction port 31-1 of the dust collecting unit 31 and the ejection port 51 of the assisting gas ejecting unit 34 face each other determine a direction 301 of the streams of air developed in the space in the dust collecting unit 31 by the ejection of the ejecting gas from the assisting gas ejecting unit 34 and the drawing of air by the suction source 32. In the laser processing apparatus 1 according to modification 1, therefore, the directions in which the laser beam applying unit 20 and the workpiece 100 move relatively to each other and the direction 301 of the streams of air extend perpendicularly to each other.

The laser processing apparatus 1 according to modification 1 produces streams of air in the dust collecting unit 31 along the direction 301 that is perpendicular to the directions in which the X-axis moving unit 61 moves, and moves the laser beam applying unit 20 reciprocally, i.e., on forward and backward strokes, relatively to the workpiece 100 along the projected dicing lines 102 on the workpiece 100 while applying the laser beam 25 to the workpiece 100, thereby forming a plurality of laser-processed marks 200, i.e., laser-processed marks 200-1, 200-2, 200-3, and 200-4 on the face side 101 of the workpiece 100 to form laser-processed grooves in the face side 101 of the workpiece 100 along the projected dicing lines 102.

In the laser processing apparatus 1 thus configured according to modification 1, the directions in which the X-axis moving unit 61 moves and the direction 301 of the streams of air extend perpendicularly to each other and the angle formed between those directions remains the same on a forward stroke of movement of the laser beam applying unit 20 and on a backward stroke of movement of the laser beam applying unit 20. Therefore, the laser processing apparatus 1 according to modification 1 is able to draw plasma or debris produced at the processing spot along the direction 301 of the streams of air with the debris discharging unit 30 equally on the forward stroke of movement of the laser beam applying unit 20 and on the backward stroke of movement of the laser beam applying unit 20, without being adversely affected by the relative movement of the laser beam applying unit 20. The laser processing apparatus 1 according to modification 1 is thus advantageous in that it can obtain equal results of laser beam processing on the forward stroke of movement of the laser beam applying unit 20 and on the backward stroke of movement of the laser beam applying unit 20.

### [Modification 2]

A laser processing apparatus 1 according to modification 2 of the present embodiment will be described below with reference to FIG. 6. FIG. 6 illustrates in plan the manner in which the laser processing apparatus 1 according to modification 2 of the embodiment operates. Those parts illustrated in FIG. 6 that are identical to those according to the embodiment and modification 1 are denoted by identical reference characters and will not be described in detail below.

As illustrated in FIG. 6, in the laser processing apparatus 1 according to modification 2, the directions in which the X-axis moving unit 61 moves to move the workpiece 100 in the X-axis directions, i.e., the processing feed directions, and the directions along which the suction port 31-1 of the dust collecting unit 31 and the ejection port 51 of the assisting gas ejecting unit 34 face each other as viewed in plan extend parallel to each other. The ejection port 51 of the assisting gas ejecting unit 34 is positioned on a downstream side, i.e., on a forward side, with respect to the direction in which the X-axis moving unit 61 moves, whereas the suction port 31-1 of the dust collecting unit 31 is positioned on an upstream side, i.e., on a backward side, with respect to the direction in which the X-axis moving unit 61 moves. Consequently, in the laser processing apparatus 1 according to modification 2, the assisting gas ejecting unit 34 ejects the assisting gas from the downstream side with respect to the direction in which the laser beam applying unit 20 moves, and the suction source 32 draws air from the upstream side with respect to the direction in which the laser beam applying unit 20 moves, forming a direction 302 of the streams of air developed in the space in the dust collecting unit 31 from the downstream side toward the upstream side with respect to the direction in which the laser beam applying unit 20 moves.

The laser processing apparatus 1 according to modification 2 produces streams of air in the dust collecting unit 31 from the downstream side toward the upstream side with respect to the direction in which the X-axis moving unit 61 moves, and moves the laser beam applying unit 20 only in one particular direction relatively to the workpiece 100 along the projected dicing lines 102 while applying the laser beam 25 to the workpiece 100, thereby forming a plurality of laser-processed marks 200 on the face side 101 of the workpiece 100 to form laser-processed grooves in the face side 101 of the workpiece 100 along the projected dicing lines 102.

Inasmuch as the laser processing apparatus 1 according to modification 2 moves the laser beam applying unit 20 only in one particular direction relatively to the workpiece 100, the laser processing apparatus 1 according to modification 2 can draw and remove plasma or debris more efficiently by drawing plasma or debris produced at the processing spot along the direction 302 of the streams of air from the downstream side to the upstream side with respect to the direction in which the laser beam applying unit 20 moves. The laser processing apparatus 1 according to modification 2 is therefore advantageous in that it can more effectively prevent plasma or debris produced at the processing spot from interacting with the laser beam 25.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a chuck table for holding a plate-shaped workpiece thereon;
a laser beam applying unit including a beam condenser for applying a laser beam to a face side of the workpiece held on the chuck table to form laser-processed grooves in the workpiece by way of ablation; and
a debris discharging unit disposed in a space between the beam condenser and the workpiece on the chuck table, for drawing and discharging debris produced at a processing spot on the workpiece by the laser beam applied to the face side of the workpiece,
wherein the debris discharging unit includes
a dust collecting unit, and
a suction source connected to the dust collecting unit, and
the dust collecting unit includes
a slanted portion including a transmitting portion for allowing the laser beam to pass therethrough and having a first side adjacent to the workpiece on the chuck table and a second side remote from the first side,
a ceiling coupled to the second side,
a bottom wall having an opening defined therein for allowing the laser beam to pass therethrough, at a position aligned with the transmitting portion, the bottom wall being coupled to the first side, and
a side wall extending from the ceiling and the slanted position to the bottom wall.

2. The laser processing apparatus according to claim 1, wherein the slanted portion is inclined with respect to the bottom wall at an angle ranging from 20 to 40 degrees.

3. The laser processing apparatus according to claim 1, wherein the debris discharging unit has an ejection port defined closely to the opening, and further includes an assisting gas ejecting unit for ejecting a gas from the ejection port toward the face side of the workpiece on the chuck table to blow away the debris produced at the processing spot into the dust collecting unit.

4. The laser processing apparatus according to claim 3, wherein the assisting gas ejecting unit is oriented with respect to the slanted portion at an angle that is 10 degrees±an angle perpendicular to the slanted portion.

5. The laser processing apparatus according to claim 1, wherein the dust collecting unit has a reduced-diameter section that is progressively smaller in diameter from the suction source toward the processing spot.
